(19) United States
(12) Patent Application Publication
(10) Pub. No.: US 2026/0260490 A1
(43) Pub. Date: Sep. 3, 2026

(54) CAUSAL ANOMALY DETECTION

(71) Applicant: Dell Products L.P., Round Rock, TX (US)

(72) Inventors: Zijia Wang, London (GB); Michael Robillard, Shrewsbury, MA (US); Yichun Xu, Everett, MA (US); Xuebin He, Westwood, MA (US); Robert Lee, Marlborough, MA (US); Trevor Scott Conn, Leander, TX (US); Ramona Devi, San Jose, CA (US); Rushiv Arora, Boston, MA (US)

(21) Appl. No.: 19/068,598

(22) Filed: Mar. 3, 2025

(51) Int. Cl. G06V 20/40; G06V 40/16; G10L 15/26

(52) U.S. Cl. CPC G06V 20/44; G06V 20/41; G06V 40/176; G10L 15/26

(57) ABSTRACT

A method implemented at a computing system for detecting anomalies in video frames. The method includes a temporal dependency machine-learning (ML) model determining a set of temporal features that encapsulate temporal dependencies across received video frames at the computing system; A semantic injection ML model injects semantic information into the set of temporal features to thereby generate a set of enhanced temporal features. The semantic information defines contextual information about visual content of the received video frames. An anomaly detection ML model performs anomaly detection on the set of enhanced temporal features to thereby determine if the received video frames include deviations from expected patterns within the video frames, the deviations indicating that an anomaly has been captured in the video frames

### TECHNOLOGICAL FIELD OF THE DISCLOSURE

Embodiments disclosed herein generally relate to anomaly detection. More particularly, at least some embodiments relate to systems, hardware, software, computer-readable media, and methods for anomaly detection in retail settings.

### BACKGROUND

The accelerating pace of digital transformation in retail is catalysed by immersive technologies that facilitate complex interactions between humans and Al-driven systems. In contemporary retail, the ability to swiftly identify and respond to customer behavior anomalies is paramount, yet current systems lack real-time processing and contextual understanding. These limitations hinder the effective resolution of issues and optimization of customer interactions, necessitating a robust solution that integrates advanced analytics with immersive technology.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of a retail location where embodiments disclosed herein may be practiced.

FIG. 2 discloses aspects of an anomaly detection system according to the embodiments disclosed herein.

FIGS. 3A and 3B disclose aspects of a semantic injection model according to the embodiments disclosed herein.

FIG. 4 discloses aspects of training an anomaly detection model according to the embodiments disclosed herein.

FIG. 5 discloses aspects of operating an anomaly detection model according to the embodiments disclosed herein.

FIG. 6 discloses further aspects of an anomaly detection system according to the embodiments disclosed herein.

FIG. 7 discloses aspects of a method according to the embodiments disclosed herein.

FIG. 8 discloses a computing entity configured and operable to perform any of the disclosed methods, processes, and operations.

### DETAILED DESCRIPTION OF SOME EXAMPLE EMBODIMENTS

Embodiments disclosed herein generally relate to anomaly detection. More particularly, at least some embodiments relate to systems, hardware, software, computer-readable media, and methods for anomaly detection in retail settings.

In some aspects, the techniques described herein relate to a method implemented at a computing system for detecting anomalies in video frames, the method including: determining, via a temporal dependency machine-learning (ML) model, a set of temporal features that encapsulate temporal dependencies across received video frames at the computing system; injecting, via a semantic injection ML model, sematic information into the set of temporal features to thereby generate a set of enhanced temporal features, the sematic information defining contextual information about visual content of the received video frames; and performing, via an anomaly detection ML model, anomaly detection on the set of enhanced temporal features to thereby determine if the received video frames include deviations from expected patterns within the video frames, the deviations being indicative that an anomaly has been captured in the video frames.

In some aspects, the techniques described herein relate to a computing system for detecting anomalies in video frames including: one or more processors; and one or more non-transitory computer-readable hardware storage devices having stored thereon computer-executable instructions that are structured such that, when executed by the one or more processors, the computer-executable instructions causing the computing system to perform at least: determine, via a temporal dependency machine-learning (ML) model, a set of temporal features that encapsulate temporal dependencies across received video frames at the computing system; inject, via a semantic injection ML model, sematic information into the set of temporal features to thereby generate a set of enhanced temporal features, the sematic information defining contextual information about visual content of the received video frames; and perform, via an anomaly detection ML model, anomaly detection on the set of enhanced temporal features to thereby determine if the received video frames include deviations from expected patterns within the video frames, the deviations being indicative that an anomaly has been captured in the video frames.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The accelerating pace of digital transformation in retail is catalyzed by immersive technologies that facilitate complex interactions between humans and Al-driven systems. In contemporary retail, the ability to swiftly identify and respond to customer behavior anomalies is paramount, yet current systems lack real-time processing and contextual understanding. These limitations hinder the effective resolution of issues and optimization of customer interactions, necessitating a robust solution that integrates advanced analytics with immersive technology.

In particular, in the retail sector there is a need to identify and analyze customer anomalies to enhance business operations and decision making. Anomaly detection refers to the identification of events or observations in data that do not conform to an expected pattern, often signaling errors or significant operational deviations. In the context of retail, anomaly detection is pivotal for recognizing unusual customer behaviors or irregularities in store operations that could indicate potential fraud, shoplifting, security issues, or operational inefficiencies. However, existing anomaly detection systems and methods are not good at open world applications, which have unforeseen conditions.

Accordingly, at least some of the embodiments disclosed herein provide for anomaly detection in retail settings that emphasizes the integration of advanced machine learning (ML) techniques and immersive technologies to enhance business operations. Such embodiments leverage large pre-trained ML models to detect and categorize both common and unprecedented anomalies by analyzing video data. This approach ensures a robust and adaptable system capable of handling diverse retail environments and varying scenarios.

The embodiments disclosed herein implement one or more machine learning models. As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

At least some embodiments disclosed herein include the use of novel semantic knowledge injection and anomaly synthesis modules. The semantic knowledge injection module enhances anomaly detection by incorporating rich contextual understandings, which allows the system to recognize subtle cues and patterns that may indicate unusual activities. Additionally, the anomaly synthesis module generates synthetic data representing rare or novel events, which further trains and refines a ML model, ensuring the model remains effective as new types of anomalies emerge. These components help ensure high accuracy and low false positives in real-world applications, providing substantial value to retail operators by enabling more secure and efficient operations. Of course, the embodiments disclosed herein are also applicable to anomaly detection in non-retail scenarios as well. Thus, the discussion of use of the embodiments in retail s scenarios is only a non-limiting example of possible scenarios.

At least some embodiments of a semantic knowledge injection module disclosed herein provide for the use of Language Models (LLMs) to significantly enhance a dataset used for training and operational deployment. In some embodiments a Speech-to-Text (STT) tool is utilized to allow spoken interactions or narrations within retail spaces to be converted into textual data, which can then be analyzed by the LLMs. Additionally, the LLMs are employed to generate descriptive annotations of video frames, which are then utilized to detect anomalies. The descriptive annotations help identify deviations from normal behavior and also help to determine the underlying causes (‘why’), the specific nature of the anomaly (‘what’), and its subsequent impacts (‘effect’). This dual application of the LLMs not only augments the dataset with rich, contextual data but also improves the model's ability to discern and classify nuanced activities within video footage.

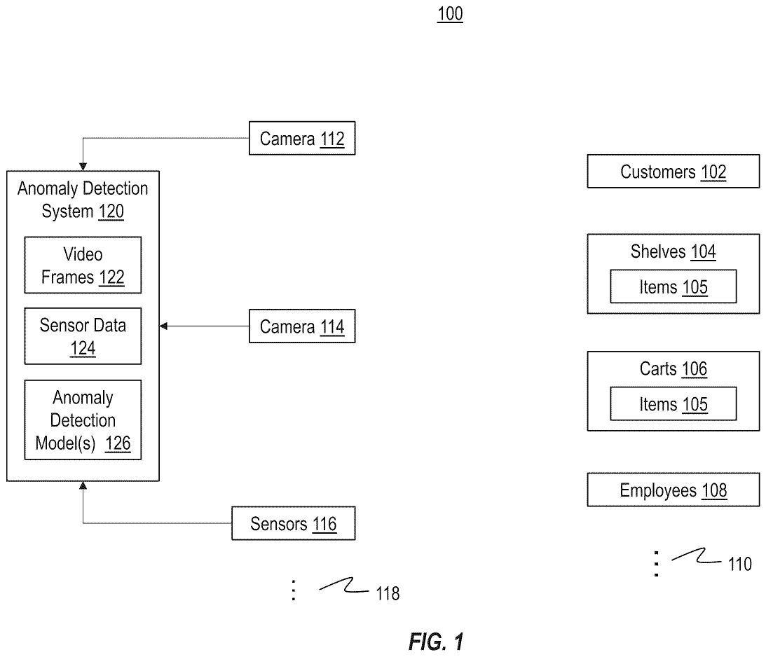

FIG. 1 illustrates an embodiment of a retail location 100, such as a grocery store or department store. As illustrated, one or more customers 102 access the retail location 100 to shop for items 105 provided by the retail location 100. During their shopping experience, the customers 102 can access shelves 104 that located in the retail location 100 to pick the items 105 from the shelves 104 that they desire to purchase. In some embodiments, especially if the retail location 100 is a grocery store or the like, the customers 102 can use one or more shopping carts 106 to place the desired items 105 they have taken from the shelves 104 until such time as they purchase the items. It will be appreciated that the use of term shopping carts 106 is also intended to include shopping baskets, shopping bags, or any other implement that a customer 102 can use to place the desired items 105 they have taken from the shelves 104 until such time as they purchase the items.

The retail location 100 also includes one or more employees 108 who work at the retail location to provide services to the customers 102. For example, the employees 108 can be checkers who receive payment from the customers for purchase of the items 105, security staff, or custodial staff who clean the retail location 100. The ellipses 110 represent that there can be additional people in the location 100 such as suppliers who provide the items 105.

The retail location 100 includes a camera 112, a camera 114, and one or more sensors 116. There can also be any number of additional cameras and/or sensors 118 that are placed in the retail location 100 as represented by the ellipses. In operation, the camera 112, the camera 114, the one or more sensors 116, and potentially the additional cameras and sensors 118 monitor various different rooms of retail location 100 such a main room where the customers 102 shop as well as any storerooms, break rooms, and the like that are frequented by the employees 108, and monitor the customers 102, the shelves 104, the shopping carts 106, and the employees 108.

In some embodiments, one or more of the cameras 112 and 114 can be a depth camera. A depth camera is a specialized camera that measures the distance between itself and objects in a scene, essentially providing a 3D perspective by assigning a “depth” value to each pixel in an image, allowing it to not only capture what an object looks like but also how far away it is from the camera; this information is often represented as a depth map where different colors or values correspond to different distance. Of course, one or more of the cameras 112 and 114 can be other types of cameras as well. In some embodiments, the one or more sensors 116 can be motion sensors that detect the actions of the customers 102, the carts 106, and/or the employees 108 such as motion sensors, fall detection sensors, gravity sensors, or the like.

The retail location 100 also includes an anomaly detection system 120. The anomaly detection system 120 can be comprises of a computing system that is local to the retail location 100 or it can be a distributed computing system that has components that reside in the cloud or that are not located at the retail location 100. In operation, the anomaly detection system 120 receives video frames 122 from the camera 112 and the camera 114 and sensor data 124 from the one or more sensors 116.

The anomaly detection system 120 includes one or more anomaly detection models 126. As will be explained in more detail to follow, the one or more anomaly detection models 126 perform anomaly detection using the video frames 122 and/or the sensor data 124. As will also be explained in more detail to follow, the anomaly detection system 120 includes other components that allow the anomaly detection system 120 to provide useful information to a user based on the video frames 122 and/or the sensor data 124.

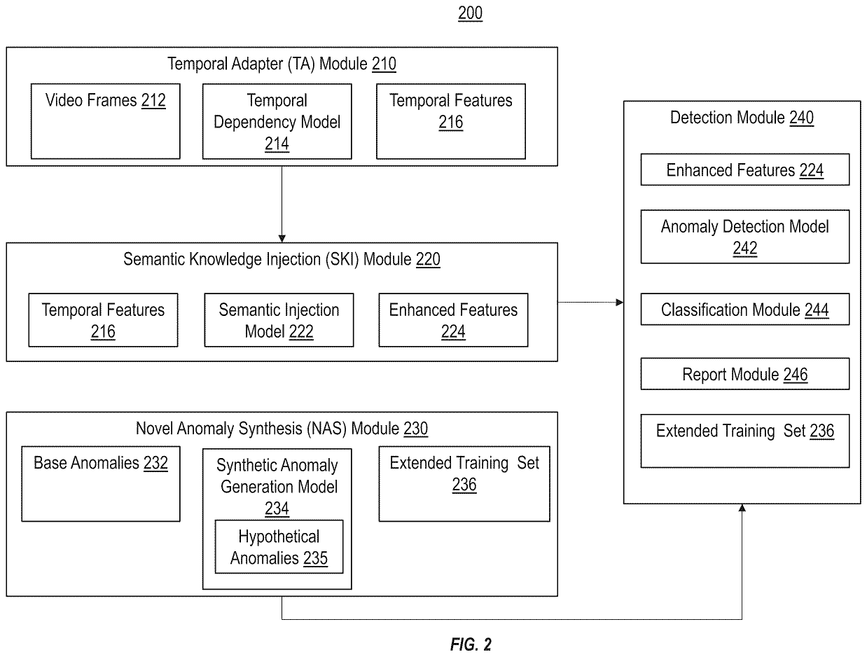

FIG. 2 illustrates an embodiment of an anomaly detection system 200 that corresponds to the anomaly detection system 120. As illustrated, the anomaly detection system 200 includes a Temporal Adapter (TA) module 210. In operation, the TA module 210 is designed to capture temporal dependencies across video frames that can be used in the anomaly detection. Temporal dependencies across video frames refer to the relationships or dependencies between consecutive or non-consecutive frames in a video sequence. Since videos are essentially a series of frames (images) shown in quick succession, it is useful to understand how this information evolves over time.

Accordingly, the TA module 210 receives a set of video frames 212 such as the video frames 122 from various cameras such as the cameras 112 and 114. The video frames 212 are then fed to a temporal dependency model 214, which processes the temporal dependencies between consecutive or non-consecutive frames in the video sequence. In some embodiments, the temporal dependency model 214 can be a pretrained vison model such as the image part of a Contrastive Language-Image Pre-training (CLIP) model, although any model that is able to processes the temporal dependencies between consecutive or non-consecutive frames in the video sequence can be used.

In one embodiment, the temporal dependency model 214 processes the video frames 212 by using a weight-free mechanism to model the temporal dependencies effectively. Specifically, it employs a graph convolutional network approach where adjacency matrices represent the relationships between consecutive frames. It can be mathematically modelled as:

$${H}_{( i , j )} = \frac{- \vert i - j \vert}{σ}$$

where i and j are the temporal location of frame i and j, and H is the adjacency matrices. Then the new feature for each frame becomes:

$${x}_{t} = LN ( softmax ( H ) {x}_{f} )$$

The output of the temporal dependency model 214 is a set of temporal features 216 in a vector or embedding form that encapsulate the dynamics and progression of activities within the video frames 212. This provides a temporally coherent feature set that will be used further during the anomaly detection process.

As illustrated, the anomaly detection system 200 includes a Semantic Knowledge Injection (SKI) module 220. In operation, the SKI module 220 receives the temporal features 216 from the TA module 210. The temporal features 216 are then fed to a semantic injection model 222, which encodes external semantic knowledge to the temporal features 216. The external semantic knowledge can be based on contextual understanding of the temporal features 216. The semantic injection model 222 outputs is enhanced features 224 that are rich in both semantic and temporal context, thus improving anomaly detection system 200 accuracy by providing a deeper understanding of the scenarios depicted in the video frames 212.

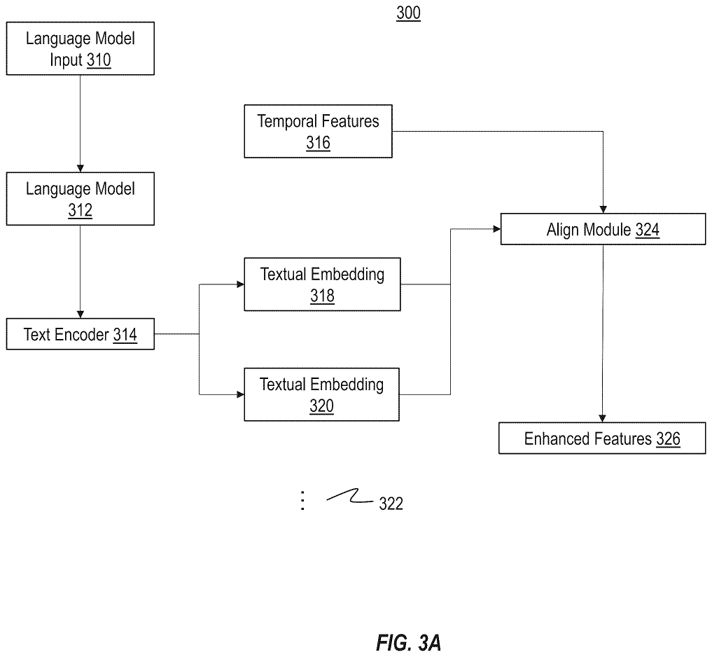

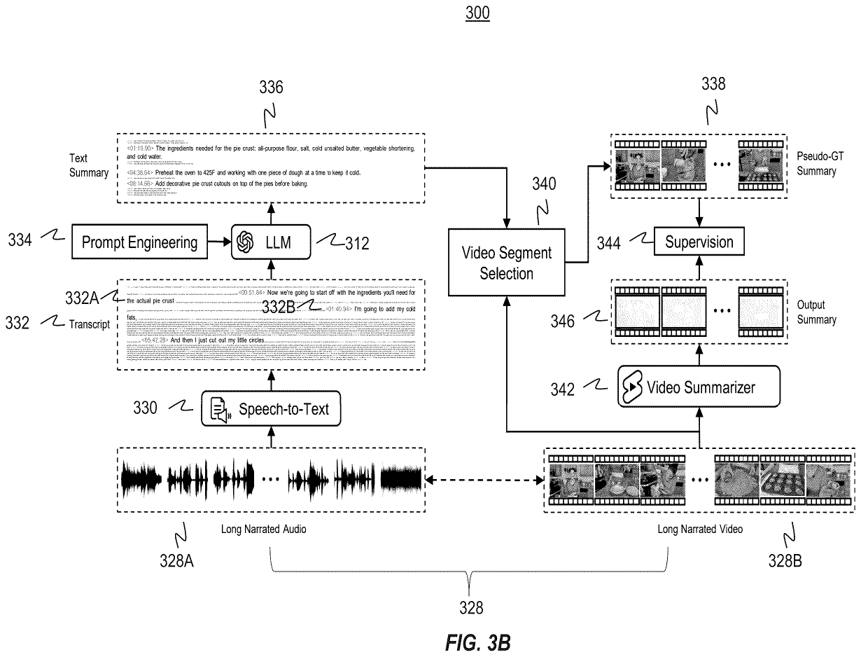

FIG. 3A illustrates an embodiment of a semantic injection model 300, which corresponds to the semantic injection model 222. The semantic injection model includes a language model (LLM) 312 that is receives language model input 310. In some embodiments, this may be a question from a user about if there is an anomaly seen in the video frames 212. In other embodiments, a template-based prompting mechanism can be used to prompt the LLM 312. The LLM 312 outputs a text summary of the language model input 310 and provides this to a text encoder 314.

The text encoder 314, which in some embodiments can be the text encoder portion of the CLIP model, processes text summary (e.g., captions, descriptions) from the LLM 312 and converts the summary into a corresponding text embedding 318, a corresponding text embedding 320, and any number of additional text embeddings 322 as illustrated by the ellipses. The text embeddings 318-322 are then merged with the temporal features 316, which correspond to the temporal features 216, in an alignment module 324.

In some embodiments, the alignment module 324 uses cross-modal alignment techniques, such as cosine similarity or dot product operations, to merge the temporal features with the text embeddings. The alignment module 324 then outputs enhanced features 326, which correspond to the enhanced features 224.

FIG. 3B illustrates a further embodiment of the semantic injection model 300. As illustrated, a video frame 328, which corresponds to the video frame 212 and includes both an audio portion 328A and a video portion 328B, is received at the semantic injection model 300. A speech-to-text converter 330 accurately transcribes the audio portion 328A into written text form, providing a textual transcript 332 of the audio portion 328A. In addition, the textual transcript 332 is processed so that each sentence 332A is accompanied by its corresponding start timestamp 332B.

Once the textual transcript 332 is available, it undergoes prompt engineering 334, which structures the textual transcript 332 into prompts suitable for processing by the LLM 312. The LLM 312 then analyzes these prompts to extract and summarize key information in a text summary 336. This involves identifying significant elements like the ‘why’, ‘what’, and ‘effect’ of the video frames 328, referred to as the Pseudo-GT summary 338.

Concurrently, a video segment selection model 340, which can correspond to the CHIP model previously described, processes the video portion 328B to select relevant video segments that correspond to the textual prompts generated from the textual transcript 332. This selection targets the specific portions of the video portion 328B that contain the activities specified in the text summary 336, ensuring that the video analysis is focused and relevant.

A video summarizer 342, which can correspond to the align module 324, segments the video portion 328B, aligning it with the derived text summary 336 to create a cohesive narrative flow. The selected video segments and their corresponding textual summaries are then brought together under a supervised framework 344 that fine-tunes the alignment between video and text. This supervision ensures that a final output summary 346 is accurate and reflective of both the visual and narrated content of the video frame 328.

While the embodiment discussed in relation to FIG. 3B includes narrated videos, the embodiments disclosed herein are also adaptable to non-narrated videos. In such cases, the video frames 328 are directly input into the LLM 312, which generates text summaries 336 without the initial speech-to-text conversion step. Similarly, the text summaries 336 are processed to produce the Pseudo-GT summary 338, ensuring consistency in the analysis across different types of video content.

Returning to FIG. 2, the anomaly detection system 200 includes a Novel Anomaly Synthesis (NAS) module 230. In operation, the NAS module 230 receives a set of video frames having base anomalies 232 that the anomaly detection system 200 has been previously trained to recognize. A synthetic generation model 234 then generates synthetic video frames that represent potential new anomaly types in order to train the anomaly detection system 200 to detect novel anomalies that it has not yet seen.

In particular, the synthetic generation model 234 generates realistic video frames based on textual descriptions of hypothetical anomalies 235 that are input into the synthetic generation model 234. These synthetic video frames including the hypothetical anomalies 235 are designed to challenge and expand the synthetic generation model 234 understanding of what constitutes an anomaly, ensuring that the anomaly detection system 200 is not limited to the types of anomalies it has previously encountered.

Once the synthetic video frames including the hypothetical anomalies 235 have been generated, the synthetic generation model 234 creates an extended training set 236. The extended training set 236 includes both the video frames having the real base anomalies 232 that have been encountered before and the synthetic video frames including the hypothetical anomalies 235. As will be explained in more detail to follow, the extended training set 236 is used to train an anomaly detection model 242 to detect both known anomalies and anomalies that have never been seen before.

As illustrated, the anomaly detection system 200 includes a detection module 240. In operation, the detection module 240 receives the enhanced features 224 from the SKI module 220 and the extended training set 236 from the NAS module 230. The enhanced features 224 and the extended training set 236 are then used to train the anomaly detection model 242. Once trained, the anomaly detection model 242 is able to detect anomalies in the received video frames 212 by performing anomaly detection analysis on the enhanced features 224 to identify deviations from expected patterns within the video frames. The deviations are indicative that the video frames 212 have captured an anomaly in the retail location 100 such as theft or a customer or employee falling down.

A classification module 244 is able to categorize any detected anomalies into specific anomaly types based on their alignment with pre-trained textual features of known anomaly categories. This step can involve matching the feature vectors of detected anomalies against a library of anomaly categories using similarity scoring. A report module 246 is able to produce detailed anomaly reports, which not only identify the presence of an anomaly but also categorize each detected anomaly into known classes, providing actionable insights into the nature and type of each anomaly.

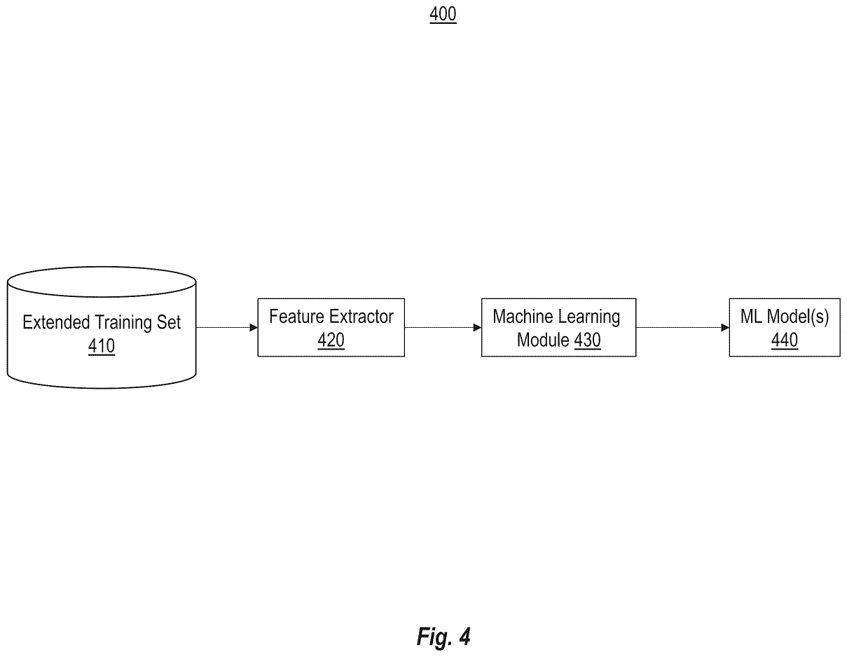

FIG. 4 illustrates an example machine-learning network 400 configured to train one or more machine-learning models 440, which corresponds to the anomaly detection model 242. An extended training set 410, which corresponds to the extended training set 236, includes both the video frames having the real base anomalies 232 that have been encountered before and the synthetic video frames including the hypothetical anomalies 235. The extended training set 410 is processed by a feature extractor 420 configured to extract a plurality of features from the video frames which correspond to the real base anomalies 232 and the hypothetical anomalies 235 in the extended training set 410.

A machine learning module 430 is then configured to analyze the plurality of features from the video frames corresponding to the different anomalies to train the one or more machine-learning models 440. The one or more machine-learning model(s) 240 are trained to detect anomalies in received video frames 212. For example, for a given received video frame, the one or more machine-learning model(s) 240 are configured to determine a probability that the given received video frame is anomalous compared to the video frames for both the real base anomalies 232 and the hypothetical anomalies 235 contained in the extended training set 410.

Different machine-learning techniques may be implemented in training the anomaly detection models. In some embodiments, distance-based anomaly detection techniques are used to train a model to detect a distance between a newly received video frame and an expected video frame. In some embodiments, clustering-based anomaly detection techniques are used to train a model to detect whether a newly received video frame is within one or more clusters. Many different algorithms may be used to train the models, including supervised and non-supervised training, e.g., (but not limited to) logistic regression, isolation forest, k-nearest neighbors, support vector machines (SVM), deep learning classifiers, density-based algorithm, elliptic envelope, local outlier factor, Z-score, Boxplot, statistical techniques, and/or time series techniques.

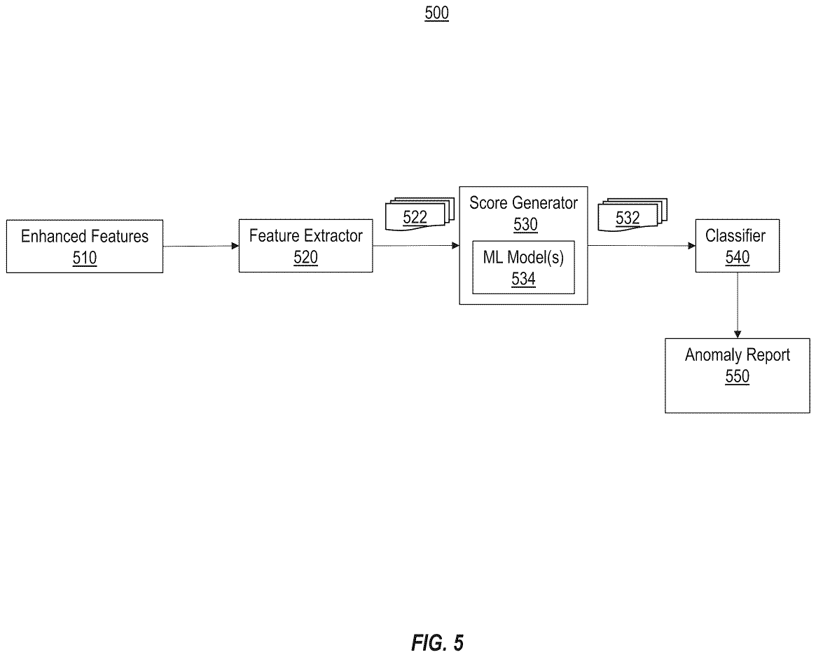

FIG. 5 illustrates an example embodiment of a detection module 500 that corresponds to the detection module 240. As illustrated in FIG. 5, the detection module 500 includes a feature extractor 520 that extracts a plurality of features 522 from enhanced features 510, which correspond to enhanced features 224.

The extracted plurality of features 522 are then fed into a score generator 530. The score generator 530 includes one or more machine-learning model(s) 534 that correspond to the machine-learning model(s) 440 of FIG. 4 trained on extended training set 410 and the anomaly detection model 242. The one or more machine-learning model(s) 534 can generate a probability score 532, indicating a probability that one or more of the video frames 212 associated with the enhanced features 510 includes deviations from expected patterns within the video frames, where the deviations indicate that an anomaly has been captured in the video frames.

The probability score 532 is then processed by a classifier 540, which corresponds to the classification module 244. In some embodiments, when the probability score 532 is less than a predetermined threshold, the list classifier 540 determines that the video frame is not anomalous (i.e., does not include deviations from expected patterns within the video frames). However, when the probability score is more than the predetermined threshold, the classifier 540 determines that the video frames are anomalous (i.e., does include deviations from expected patterns within the video frames). In such case, the classifier 540 is able to label what type of anomaly is seen in the video frame based on a comparison of the determined anomaly with known anomalies. That is, if the anomaly of the video frame is similar to a known anomaly based on a similarity score, the video frame is labeled as that type of anomaly. If the anomaly of the video frame is not similar to a known anomaly, then the video frame is labeled as a new anomaly classification. Once the anomalies have been determined and classified, an anomaly report 550 is generated a report module such as the report module 246.

Accordingly, the embodiments disclosed herein provide for the novel combination of the TA module 210 and the SKI module 220. The TA module 210 uses a nearly weight-free mechanism to model temporal dependencies in video frames, enhancing the anomaly detection system's ability to understand and interpret actions over time without the heavy computational overhead typically associated with temporal data processing. The SKI module further enhances detection by infusing semantic knowledge from large language models into the video frames, providing a richer contextual backdrop that improves the system's ability to accurately identify and categorize anomalies. This dual-module integration allows for a robust detection of anomalies by not only recognizing unusual activities based on their appearance but also understanding them in a contextual framework.

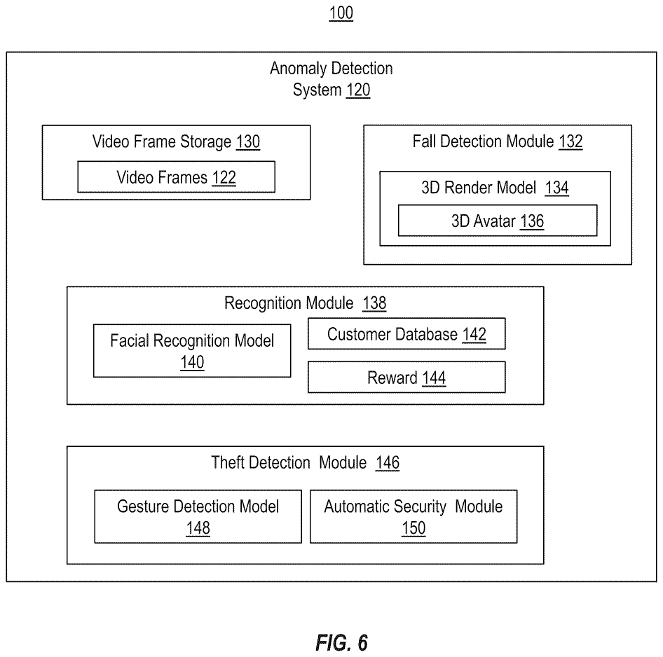

Attention is given to FIG. 6, which show a further embodiment of the deployment of the anomaly detection system 120 in the retail location 100. As previously described, the anomaly detection system 120 performs anomaly detection using the anomaly detection models and labels or classifies a video frame where an anomaly has been found. In the embodiment of FIG. 6, the anomaly detection system 120 includes a video frame storage 130 that is used to store the video frames 122. In the embodiment, once a given video frame has been labeled with an anomaly, the given video frame is stored for future reference, including legal purposes. As for the video frames that do not show any anomalies, they will be either discarded or zipped and stored in alternative ways according to different regulations of different retail locations to thus ensure that the video frame store 130 only includes those video frames that do include an anomaly.

One particular type of anomaly that is important for the retail location 100 to fully document is fall detection of a customer 102 and/or an employee 108 as this can often lead to legal and/or insurance issues for the owner of the retail location 100. Accordingly, in some embodiments the anomaly detection system 120 includes a fall detection module 132. In operation, the fall detection module 132 access those video frames 122 stored in the video frame storage 130 has been labeled as showing a fall anomaly. In other embodiments, once a the fall anomaly is detected, the fall detection module 132 may direct the one or more of the cameras 112 and 114 to continually monitor and record video frames of the location of the fall so that no video frames are lost. Because the video frames 122 are typically captured by a camera 112 and/or 114 that is a depth camera, the fall detection module 132 is able to create a 3D rendering of the fall using a 3D avatar.

In more detail, the fall detection module 132 can include a 3D render model 134 that generates a 3D avatar 136 of the fall victim. For example, suppose that a customer 102 fell while walking inside the retail location 100. In such case, the 3D render model 134 can generate a 3D avatar 136 of the customer that fell. While traditional video clips only allow viewing from one perspective, which is watching the video from where the camera is mounted, the 3D avatar 136 can be dragged and rotated to be watched from various perspectives. This capability allows for a comprehensive analysis of the customer's movements. For example, people who tripped and slipped have different behaviors and postures at fall down. This data aids in more accurate determination of the causes behind the fall, helping with incident analysis and preventive measures.

In some embodiments, anomaly detection system 120 includes a recognition module 138. The recognition module includes a facial recognition model 140 which can be any reasonable facial recognition model. In operation, the facial recognition model 140 can use the cameras 112 and 114 to capture the faces of the customers 102 or the facial recognition model 140 can access the video frames 122 stored in the video frame storage 130 to identify the customers 102 who are currently shopping at the retail location 100. The facial recognition model can then access a customer database 142 to match the identity of the customers 102 who are currently shopping at the retail location 100 with the subset of customers 102 that have good credit with or are regular customers of the retail location 100. The subset of customers 102 that have good credit with or are regular customers of the retail location 100 can then be receive a reward 144 such as access to a faster checkout line or access to exclusive promotions and sales. To satisfy privacy concerns, the customers 102 who want to potentially receive the reward 144 can opt into this process through use of a phone app that allows the user to submit a pre-scanned picture of their faces to the retail location 100 for storage in the customer database 142.

In some embodiments, anomaly detection system 120 includes a theft detection module 146. In operation, the theft detection module 146 receives notice that a theft is occurring by the anomaly detection system 120 determining in the manner previously described that the anomalous actions of a customer 102 are indicative of theft.

In addition, the theft detection module includes a gesture detection model 148, which can be any reasonable gesture detection model. The gesture detection model 146 utilizes the cameras 112 and 114 to analyze customer 102 and employee 108 actions in real-time. It distinguishes between customers 102 or employees 108 placing items 105 into their shopping carts 106 and those attempting to conceal items 105 in their pockets or personal bags.

The theft detection module further includes an automatic security module 150. Once a theft has been identified (or at least suspicious behavior indicative of a theft has been identified) by the anomaly detection, the gesture detection model 148, or by some other way such as a sensor 116 reading an un-scanned barcode on an item 105, the automatic security module 150 can take actions to prevent the theft. For example, the automatic security module 150 can notify an appropriate employee 108 to take appropriate actions to prevent theft. In other embodiments, the automatic security module 150 can automatically lock an exist gate so that the customer 102 or employee 108 that is suspected of theft is not able to leave the retail location 100 until such time as the possible theft can be further investigated. This serves as an effective deterrent against theft without requiring a security guard or exit attendant. This further ensures a seamless and efficient shopping experience for the customers 102 while enhancing security and operational efficiency for the retail location 100.

The embodiments disclosed herein provide for the novel NAS module 230, which synthetically generates training data sets for anomalies that have not been previously encountered. This module leverages advancements in generative modeling to create realistic, unseen anomaly scenarios, thereby preparing the anomaly detection system 200 to handle unexpected variations in real-world settings. By training the anomaly detection system 200 on both real and synthetic data, the NAS module 230 ensures that the model remains effective even as new types of anomalies emerge, enhancing the system's adaptability and robustness.

The embodiments disclosed herein provide for a novel cross-modal alignment mechanism for categorizing anomalies. By aligning video-level features with textual embeddings of anomaly categories, the anomaly detection system 200 can not only detect but also classify anomalies into specific types, even if those anomalies were not part of the training set. This alignment is facilitated by the integration of visual and textual data, allowing for a more nuanced understanding of the anomalies, and providing detailed categorizations that go beyond simple detection.

The embodiments disclosed leverage the zero-shot learning capabilities of pre-trained language-image models like CLIP, to detect and categorize anomalies without having been explicitly trained on them. This novel application enables the anomaly detection system 200 to perform open-vocabulary detection, where the ability to recognize and classify unseen anomalies is crucial. This approach significantly extends the applicability of the anomaly detection system 200 in dynamic environments where new types of anomalies continually emerge.

### Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

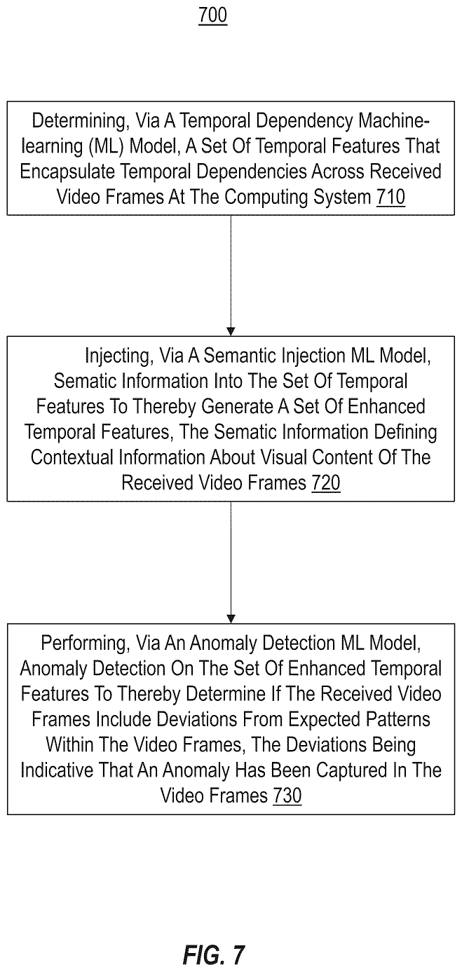

Directing attention now to FIG. 7, an example method 700 is disclosed. The method 700 will be described in relation to one or more of the figures previously described, although the method 700 is not limited to any particular embodiment.

The method 700 includes determining, via a temporal dependency machine-learning (ML) model, a set of temporal features that encapsulate temporal dependencies across received video frames at the computing system (710). For example, as previously described the TA module 210 receives the video frames 212 from the cameras 112 and 114. The temporal dependency model 214 determines the set of temporal features 216 that encapsulate temporal dependencies across the video frames 212.

The method 700 includes injecting, via a semantic injection ML model, sematic information into the set of temporal features to thereby generate a set of enhanced temporal features, the sematic information defining contextual information about visual content of the received video frames (720). For example, as previously described the SKI module 220 receives the temporal features 216 from the TA module 210. The sematic injection model 222 injects the semantic information about the video frames 212 into the temporal features 216. This may be done as previously described in relation to FIG. 3A or FIG. 3B. The results in the generation of the enhanced features 224.

The method 700 includes performing, via an anomaly detection ML model, anomaly detection on the set of enhanced temporal features to thereby determine if the received video frames include deviations from expected patterns within the video frames, the deviations being indicative that an anomaly has been captured in the video frames (730). For example, as previously described the anomaly detection model 242 performs anomaly detection on the enhanced features 224 to determine anomalies. The anomaly detection model 242 can be trained using the extended training set 236 generated by the NAS module 230 in the manner previously described.

### FURTHER EXAMPLE EMBODIMENTS

Following are some further example embodiments of the invention. These are presented only by way of example and are not intended to limit the scope of the invention in any way.

Embodiment 1. A method implemented at a computing system for detecting anomalies in video frames, the method including: determining, via a temporal dependency machine-learning (ML) model, a set of temporal features that encapsulate temporal dependencies across received video frames at the computing system; injecting, via a semantic injection ML model, sematic information into the set of temporal features to thereby generate a set of enhanced temporal features, the sematic information defining contextual information about visual content of the received video frames; and performing, via an anomaly detection ML model, anomaly detection on the set of enhanced temporal features to thereby determine if the received video frames include deviations from expected patterns within the video frames, the deviations being indicative that an anomaly has been captured in the video frames.

Embodiment 2. The method as recited in embodiment 1, wherein the anomaly detection ML model is trained using a training set generated via a synthetic anomaly generation ML model, the training set including one or more anomalies previously seen by the computing system and one or more generated synthetic anomalies not previously seen by the computing system.

Embodiment 3. The method as recited in any of embodiments 1-2, further comprising: for those received video frames that are determined to have captured an anomaly, performing an anomaly classification that determines the type of the anomaly.

Embodiment 4. The method as recited in any of embodiments 1-3, further comprising: generating an anomaly report that identifies the received video frames where an anomaly has been captured and provides a classification of the anomaly.

Embodiment 5. The method as recited in any of embodiments 1-4, wherein injecting, via a semantic injection ML model, sematic information into the set of temporal features comprises: receiving a text summary of input about the received video frames from a language ML model; converting the text summary into one or more text embeddings; and merging the one or more text embeddings with the enhanced temporal features.

Embodiment 6. The method as recited in any of embodiments 1-5, wherein injecting, via a semantic injection ML model, sematic information into the set of temporal features comprises: transcribing an audio portion of the received video frames into a text transcript; performing prompt engineering on the text transcript to structures the text transcript into one or more prompts suitable for a language ML model; providing the one or more prompts to the language ML model; receiving a text summary based on the one or more prompts from the language ML model; converting the text summary into one or more text embeddings; and merging the one or more text embeddings with the enhanced temporal features.

Embodiment 7. The method as recited in any of embodiments 1-6, wherein the computing system is deployed in a retail location and the anomaly that has been captured in the video frames is related to actions of customers or employees of the retail location, a cart being used in the retail location, or items or shelves of items in the retail location.

Embodiment 8. The method as recited in any of embodiments 1-7, wherein the anomaly that has been captured in the video frames is a fall of the customers or employees in the retail location, the received video frames being provided to a fall detection ML model that is configured to generate a 3D rendering of the fall.

Embodiment 9. The method as recited in any of embodiments 1-7, wherein the anomaly that has been captured in the video frames is a theft that has occurred in the retail location, the received video frames being provided to a gesture detection ML model that is configured to identify gestures of the customers or employees that are indicative of a theft occurring in the retail location.

Embodiment 10. The method as recited in any of embodiments 1-7, wherein the received video frames are provided to a facial recognition ML model that is configured to recognize the facial expressions of the customers in the retail location.

Embodiment 11. A computing system for performing any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-11.

### Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

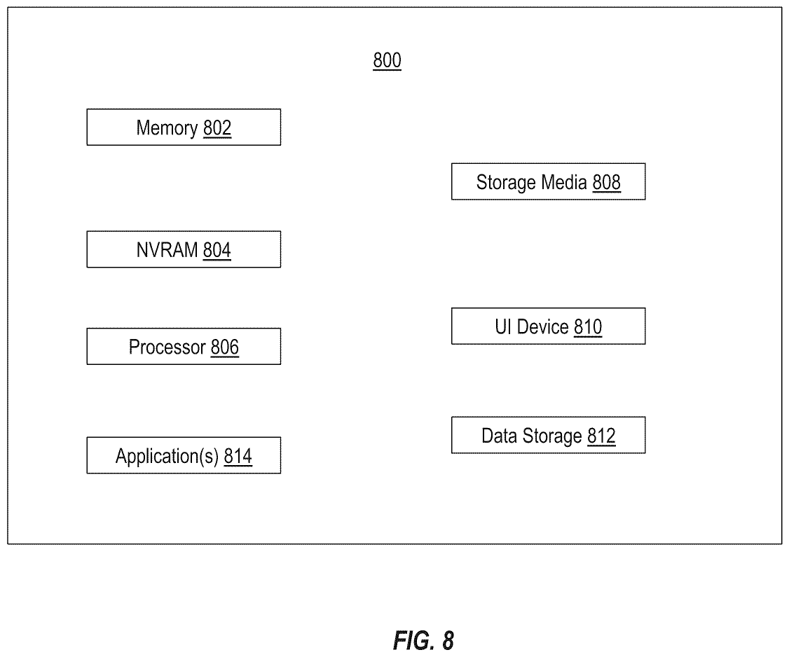

With reference briefly now to FIG. 8, any one or more of the entities disclosed, or implied, by FIGS. 1-3 and/or elsewhere herein, may take the form of, or include, or be implemented on, or hosted by, a physical computing device, one example of which is denoted at 800. As well, where any of the aforementioned elements comprise or consist of a virtual machine (VM), that VM may constitute a virtualization of any combination of the physical components disclosed in FIG. 8.

In the example of FIG. 8, the physical computing device 800 includes a memory 802 which may include one, some, or all, of random access memory (RAM), non-volatile memory (NVM) 804 such as NVRAM for example, read-only memory (ROM), and persistent memory, one or more hardware processors 806, non-transitory storage media 808, UI device 810, and data storage 812. One or more of the memory components 802 of the physical computing device 804 may take the form of solid state device (SSD) storage. As well, one or more applications 814 may be provided that comprise instructions executable by one or more hardware processors 806 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method implemented at a computing system for detecting anomalies in video frames, the method comprising:
determining, via a temporal dependency machine-learning (ML) model, a set of temporal features that encapsulate temporal dependencies across received video frames at the computing system;
injecting, via a semantic injection ML model, sematic information into the set of temporal features to thereby generate a set of enhanced temporal features, the sematic information defining contextual information about visual content of the received video frames; and
performing, via an anomaly detection ML model, anomaly detection on the set of enhanced temporal features to thereby determine if the received video frames include deviations from expected patterns within the video frames, the deviations being indicative that an anomaly has been captured in the video frames.

2. The method of claim 1, wherein the anomaly detection ML model is trained using a training set generated via a synthetic anomaly generation ML model, the training set including one or more anomalies previously seen by the computing system and one or more generated synthetic anomalies not previously seen by the computing system.

3. The method of claim 1, further comprising:
for those received video frames that are determined to have captured an anomaly, performing an anomaly classification that determines a type of the anomaly.

4. The method of claim 1, further comprising:
generating an anomaly report that identifies the received video frames where an anomaly has been captured and provides a classification of the anomaly.

5. The method of claim 1, wherein injecting, via a semantic injection ML model, sematic information into the set of temporal features comprises:
receiving a text summary of input about the received video frames from a language ML model;
converting the text summary into one or more text embeddings; and
merging the one or more text embeddings with the enhanced temporal features.

6. The method of claim 1, wherein injecting, via a semantic injection ML model, sematic information into the set of temporal features comprises:
transcribing an audio portion of the received video frames into a text transcript;
performing prompt engineering on the text transcript to structure the text transcript into one or more prompts suitable for a language ML model;
providing the one or more prompts to the language ML model;
receiving a text summary based on the one or more prompts from the language ML model;
converting the text summary into one or more text embeddings; and
merging the one or more text embeddings with the enhanced temporal features.

7. The method of claim 1, wherein the computing system is deployed in a retail location and the anomaly that has been captured in the video frames is related to actions of customers or employees of the retail location, a cart being used in the retail location, or items or shelves of items in the retail location.

8. The method of claim 7, wherein the anomaly that has been captured in the video frames is a fall of the customers or employees in the retail location, the received video frames being provided to a fall detection ML model that is configured to generate a 3D rendering of the fall.

9. The method of claim 7, wherein the anomaly that has been captured in the video frames is a theft that has occurred in the retail location, the received video frames being provided to a gesture detection ML model that is configured to identify gestures of the customers or employees that are indicative of a theft occurring in the retail location.

10. The method of claim 7, wherein the received video frames are provided to a facial recognition ML model that is configured to recognize facial expressions of the customers in the retail location.

11. A computing system for detecting anomalies in video frames comprising:
one or more processors; and
one or more non-transitory computer-readable hardware storage devices having stored thereon computer-executable instructions that are structured such that, when executed by the one or more processors, the computer-executable instructions causing the computing system to perform at least:
determine, via a temporal dependency machine-learning (ML) model, a set of temporal features that encapsulate temporal dependencies across received video frames at the computing system;
inject, via a semantic injection ML model, sematic information into the set of temporal features to thereby generate a set of enhanced temporal features, the sematic information defining contextual information about visual content of the received video frames; and
perform, via an anomaly detection ML model, anomaly detection on the set of enhanced temporal features to thereby determine if the received video frames include deviations from expected patterns within the video frames, the deviations being indicative that an anomaly has been captured in the video frames.

12. The computing system of claim 11, wherein the anomaly detection ML model is trained using a training set generated via a synthetic anomaly generation ML model, the training set including one or more anomalies previously seen by the computing system and one or more generated synthetic anomalies not previously seen by the computing system.

13. The computing system of claim 11, further comprising:
for those received video frames that are determined to have captured an anomaly, performing an anomaly classification that determines a type of the anomaly.

14. The computing system of claim 11, further comprising:
generating an anomaly report that identifies the received video frames where an anomaly has been captured and provides a classification of the anomaly.

15. The computing system of claim 11, wherein injecting, via a semantic injection ML model, sematic information into the set of temporal features comprises:
receiving a text summary of input about the received video frames from a language ML model;
converting the text summary into one or more text embeddings; and
merging the one or more text embeddings with the enhanced temporal features.

16. The computing system of claim 11, wherein injecting, via a semantic injection ML model, sematic information into the set of temporal features comprises:
transcribing an audio portion of the received video frames into a text transcript;
performing prompt engineering on the text transcript to structure the text transcript into one or more prompts suitable for a language ML model;
providing the one or more prompts to the language ML model;
receiving a text summary based on the one or more prompts from the language ML model;
converting the text summary into one or more text embeddings; and
merging the one or more text embeddings with the enhanced temporal features.

17. The computing system of claim 11, wherein the computing system is deployed in a retail location and the anomaly that has been captured in the video frames is related to actions of customers or employees of the retail location, a cart being used in the retail location, or items or shelves of items in the retail location.

18. The computing system of claim 17, wherein the anomaly that has been captured in the video frames is a fall of the customers or employees in the retail location, the received video frames being provided to a fall detection ML model that is configured to generate a 3D rendering of the fall.

19. The computing system of claim 17, wherein the anomaly that has been captured in the video frames is a theft that has occurred in the retail location, the received video frames being provided to a gesture detection ML model that is configured to identify gestures of the customers or employees that are indicative of a theft occurring in the retail location.

20. The computing system of claim 17, wherein the received video frames are provided to a facial recognition ML model that is configured to recognize facial expressions of the customers in the retail location.
